(19) United States
(12) Patent Application Publication
(10) Pub. No.: US 2008/0250314 A1
(43) Pub. Date: Oct. 9, 2008

(54) VISUAL COMMAND HISTORY

(76) Inventor: Erik Larsen, Blacksburg, VA (US)

Correspondence Address: PATTERSON & SHERIDAN, L.L.P., 3040 POST OAK BOULEVARD, SUITE 1500, HOUSTON, TX, 77056, US

(21) Appl. No.: 11/696,048

(22) Filed: Apr. 3, 2007

(51) Int. Cl. G06F 3/00

(52) U.S. Cl. 715/705

(57) ABSTRACT

Embodiments of the invention provide a visual command history for a software application. A method for generating a visual command history for a software application configured to edit a computer-aided design (CAD) drawing may include receiving a selection of a command to perform, determining an area of the CAD drawing modified by the command. When the command is performed, the method may include capturing at least one image of the area of the drawing modified by the command and storing the images in the visual command history. The visual command history is configured to maintain a record of each command performed by the software application. A user may interact with the visual command history to undo a sequence of commands performed using the software application beginning from the most recent command up to command selected from the visual command history.

### BACKGROUND OF THE INVENTION

1. Field of the Invention

The present invention generally relates to computer software. More specifically, the present invention relates to techniques for providing a visual command history for software applications.

2. Description of the Related Art

Generally, software applications provide functions which enable users to interact with the application. Many common software applications are used to compose and modify files which store graphics data (hereafter referred to as “drawings”). For example, a software application may be used to create a computer-aided design (CAD) drawing. Typically, a user of a software application selects specific functions, or commands, to compose the contents of the drawing.

In some cases, a user of an application may need to review the sequence of commands previously used to compose a drawing (referred to hereafter as a “command history”). Typically, this arises when a user wishes to reverse some changes made to a drawing. For example, a user may have mistakenly deleted an element of a CAD drawing or the user may wish to undo the colors, line types, or styles applied to elements of a CAD drawing. To provide this ability, most applications include an “undo” function that reverses the effects of previously executed commands. Conventionally, an undo function provides a command history in the form of a list of the names of previous commands, with the names ordered in the sequence in which they were executed. The user executes the undo function by selecting a listed command name, causing the effects of the corresponding command and of any subsequent commands to be undone. For example, a user wishing to undo the deletion of an element of a CAD drawing would select the command name “Delete” from the list of command names provided by the undo function. Typically, the commands are undone in reverse order beginning from the most recent command to the one selected from the undo list.

However, in some situations, the list of command names provided by the undo function may be difficult to use. For instance, an application user may have performed many commands to compose or modify a particular drawing. Additionally, the user may have repeatedly performed the same command in interacting with various elements of the drawing. In such cases, the command history provided by the undo function may consist of a long and repetitious list of command names. Thus, a user, wishing to revert to a particular point in the composition of the drawing, may find it difficult to identify the specific item of the list which will undo to the desired point. In particular, specific commands may be difficult to identify in a list of command names, since the list does not indicate which elements the commands have been applied to. Further, the list display of commands often fails to convey the visual impact that individual commands have on the drawing, making it difficult to for the user understand how a given command may have changed the visual appearance of the drawing.

Accordingly, as the foregoing discussion demonstrates, there is a need in the art for improved techniques for providing a command history for software applications.

### SUMMARY OF THE INVENTION

Embodiments of the invention provide a visual command history for a software application. A method for generating a visual command history for a software application configured to edit a computer-aided design (CAD) drawing may include receiving a selection of a command to perform, determining an area of the CAD drawing modified by the command. When the command is performed, the method may include capturing at least one image of the area of the drawing modified by the command and storing the images in the visual command history. The visual command history is configured to maintain a record of each command performed by the software application. A user may interact with the visual command history to undo a sequence of commands performed using the software application beginning from the most recent command up to a command selected from the visual command history.

The visual command history may include a single display image, e.g., an “after” image. Alternatively, the visual command history may include multiple images such as a “before” image and an “after” image, or an animation sequence illustrating the effect of the command. In one embodiment, the user may select to undo the actions of a sequence of commands listed in the visual command history from the most recent command up to a selected command.

Advantageously, the visual command history may readily convey the effect each individual command has on the drawing, making it simple to for the user understand how a given command may have changed the visual appearance of the drawing.

### BRIEF DESCRIPTION OF THE DRAWINGS

FIG. 1 is a block diagram illustrating a computer system configured to provide a visual command history, according to one embodiment of the invention.

FIGS. 2A-2B illustrate a screen display of a drawing application being used to modify a drawing, according to one embodiment of the invention.

FIGS. 3A-3B illustrate a conceptual representation of an area of a drawing modified by a sequence of commands, according to one embodiment of the invention.

FIG. 4 illustrates a screen display of a visual command history, according to one embodiment of the invention.

FIG. 5 illustrates a method for generating a visual command history, according to one embodiment of the invention.

FIG. 6 illustrates a method for displaying a visual command history to undo one or more modifications made to a drawing, according to one embodiment of the invention.

### DETAILED DESCRIPTION OF THE PREFERRED EMBODIMENTS

Embodiments of the invention provide a visual command history for a software application. In general, when a user executes a command to modify a drawing, an image (hereafter referred to as a “snapshot”) of the modified area of the drawing is captured and stored in a visual command history. In one embodiment, two snapshots may be captured, illustrating the modified area before and after command execution. Alternatively, a video snapshot, made up of a sequence of still images, may be captured to illustrate the effects of the executed command on the modified area. The visual command history may be presented to a user as part of performing an “undo” function. The visual command history may enable the user to identify a particular command to be reversed by the undo function.

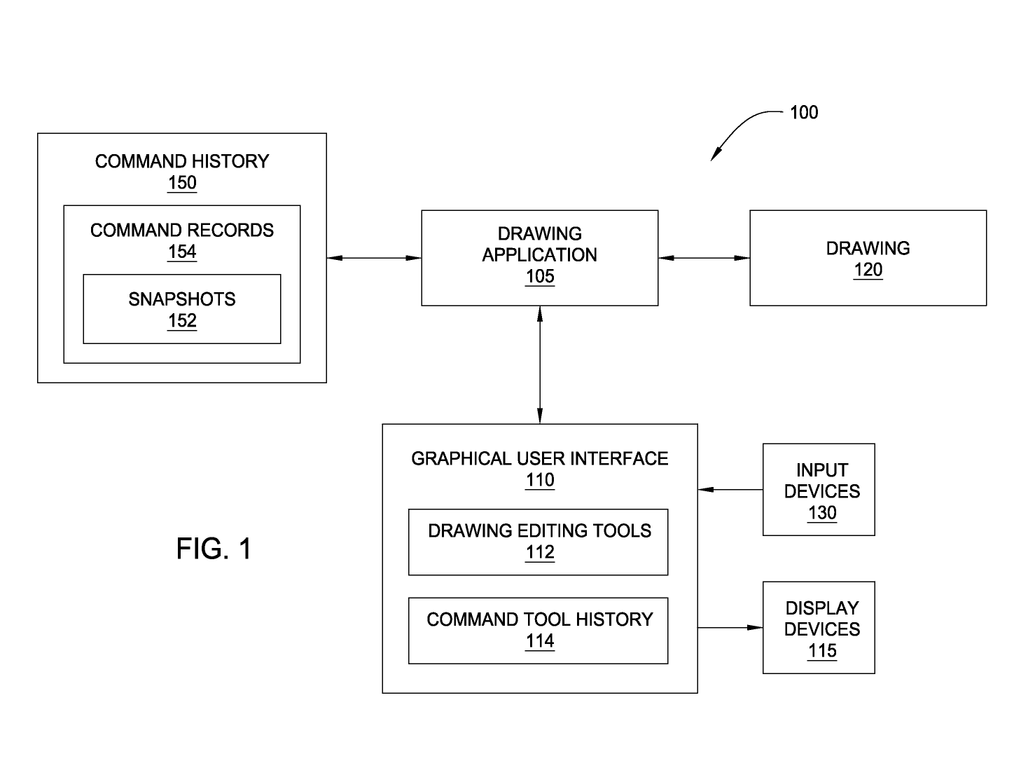

FIG. 1 is a block diagram illustrating a computer system 100 configured to provide a visual command history, according to one embodiment of the invention. The components illustrated in system 100 are included to be representative of computer software applications executing on existing computer systems, e.g., desktop computers, server computers, laptop computers, tablet computers, and the like. Of course, the software applications described herein are not limited to any particular computing system and may be adapted to take advantage of new computing systems as they become available.

Additionally, the components illustrated in system 100 may be implemented as software applications that execute on a single computer system or on distributed systems communicating over computer networks such as local area networks or large, wide area networks, such as the Internet. For example, system 100 may include a graphical user interface (GUI) 110 executing on a client computer system at one physical location communicating with a drawing application 105 at another physical location. Of course graphics application 110 and GUI 110 may be integrated as a single software application. Also, drawing application 105 and GUI 110 may be provided as an application program (or programs) stored on computer readable media such as a CD-ROM, DVD-ROM, flash memory module, or other tangible storage media.

As shown, system 100 includes, without limitation, drawing application 105, GUI 110, a drawing 120, a command history 150, display devices 115, and input devices 130. Drawing application 105 represents any software application used to compose and edit files that include graphical data. For example, drawing application 105 may be the AutoCAD® application program (and associated utilities) available from Autodesk, Inc. Drawing 120 represents any data files that include graphical data, for example, AutoCAD® drawing files.

GUI 110 provides users with a graphical interface to the functions and features of drawing application 105. GUI 110 may include any combination of graphical elements such as windows, menus, buttons, ribbons, dialog boxes, etc. Additionally, GUI 110 includes a set of drawing editing tools 112 and a command history tool 114. Drawing editing tools 112 enable users to add and modify elements of drawing 120. Command history tool 114 enables users to view and interact with command history 150.

In one embodiment, command history 150 stores data describing the commands previously executed in composing drawings 120. Command history 150 may include data of all lifetime changes made to drawing 120, or may be limited to the changes performed in a current session of editing the drawing 120. Command history 150 may be stored persistently as part of CAD drawing 120, and may include data for any commands executed by a user interacting with drawing application 105 and GUI 110. Alternatively, command history 150 may be generated and stored by drawing application 105 during an editing session. As shown, command history 150 includes command records 154. Each command record 154 may include one or more snapshots 152. In one embodiment, each command executed in drawing application 105 results in a command record 154 being added to command history 150. Each command record 154 stores data describing the specific command executed and the element(s) of the drawing 120 modified by the command. For example, command records 154 may store data describing the command name, identifier(s) of affected element(s), time of command execution, and the like. Additionally, each command record 154 includes one or more snapshots 152 which illustrate the effects of the command.

In one embodiment, each command is represented by a single snapshot 152 illustrating the results of the command on the affected element(s). That is, the snapshot 152 is captured after the command is executed. In another embodiment, each command may be represented by two snapshots 152, one illustrating the affected element(s) before the command, and another illustrating the affected element(s) after the command (i.e., “before and after” images). In yet another embodiment, each command may be represented by a video snapshot 152, i.e., an animated sequence of images illustrating the effect of the command. Snapshots 152 may be stored at a screen resolution greater than the resolution used when displaying drawing 120 in GUI 110. For example, if the command only modifies a small portion of the overall drawing, than the snapshot may “zoom-in” on the affected area, so that the captured snapshot effectively conveys how the command actually modified the drawing. Alternatively, snapshots 152 may be stored at a smaller resolution. The smaller resolution may be used, for example, to reduce the storage requirements for snapshots 152. Generally, what snapshots are captured and stored in a command record may be tailored to suit the needs of a particular user. For example, the GUI 110 may include a configuration tool (not shown) that allows a user to specify what to capture in a command record for a given command and what commands to store as command records in the visual command history. By capturing the effect of some commands at different resolutions, the visual command history may detail how a variety of commands actually modify the drawing.

User input devices 130 typically include a mouse and a keyboard, and display devices 115 may include LCD or CRT displays. One of ordinary skill in the art will recognize, however, that the elements of system 100 shown in FIG. 1 have been simplified to highlight features of the present invention and that a typical system 100 may include a variety of additional elements and/or components.

As described, command history 150 may be provided as part of an undo function included in drawing application 105. Thus, command history 150 may be used to reverse the effects of one or more commands performed by a user interacting with drawing application 105 and GUI 110.

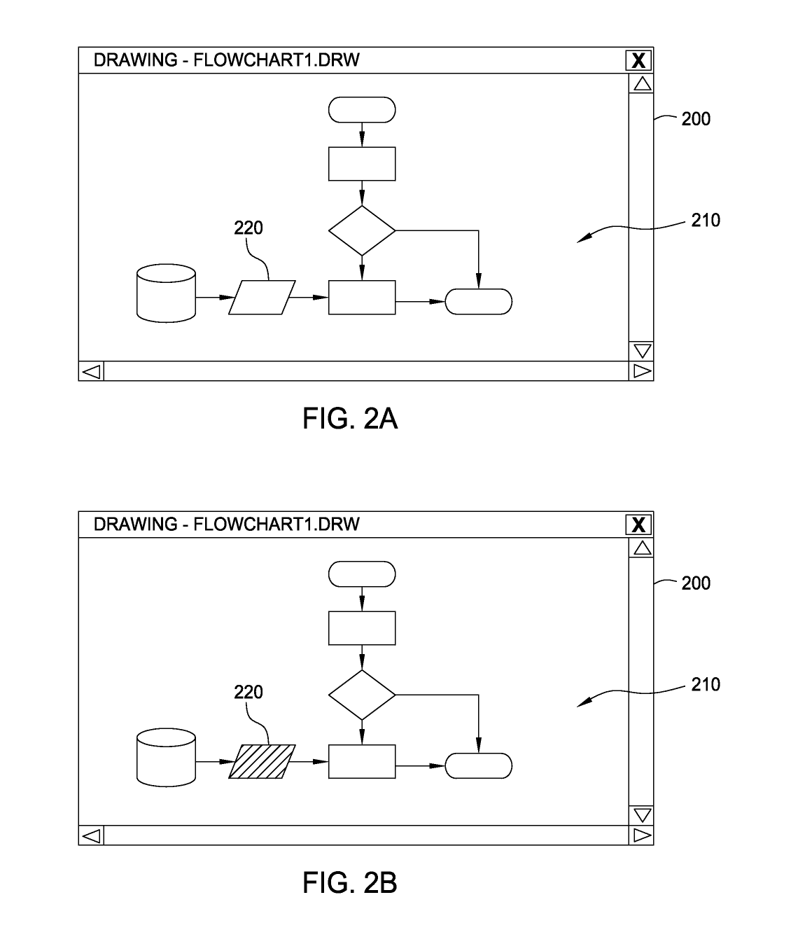

FIGS. 2A-2B illustrate a screen display 200 of drawing application 105 being used to modify a drawing 210, according to one embodiment of the invention. As shown in FIG. 2A, drawing 210 includes a flowchart made up of several graphical elements (e.g., boxes, arrows, ovals, etc.) One such element is a parallelogram 220, representing a data object. Referring now to FIG. 2B, screen display 200 shows the effect of a typical user command; specifically, the effect of a command to fill-in parallelogram 220 with a solid color. This command may be added to command history 150. That is, data related to the execution of this “fill” command may be stored as a command record 154, including one or more snapshots 152.

In one embodiment, snapshots 152 illustrate the effect of a command from various perspectives and/or levels of detail to convey how the command affects the appearance of drawing 120. For instance, snapshots 152 may be a view of a portion of drawing 120 displayed in an active window, an active tab, or an active viewport of GUI 110. Additionally, snapshots 152 may be generated by “zooming in” on a relevant portion of a display of a drawing modified by the command. The modified area used to generate a given snapshot may be set such that the effect of the command on the drawing 120 is conveyed by the snapshot. Thus, the affected area typically includes the element(s) modified by a given command, as well as enough surrounding area to provide a visual context for the element(s).

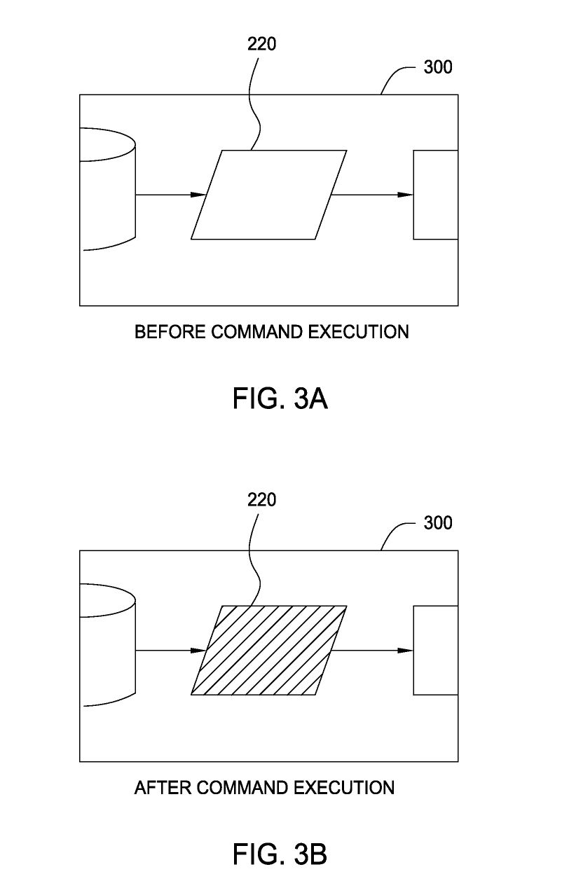

As shown in FIG. 3A, snapshot 300 illustrates parallelogram 220 before being modified. That is, before “fill” command is applied to parallelogram 220. In contrast, FIG. 3B shows snapshot 310 which illustrates parallelogram 220 after the “fill” command has been applied to parallelogram 220. Notably, snapshots 300 and 310 are limited to an affected area around parallelogram 220. In the example illustrated in FIGS. 3A-3B, the snapshots 300 and 310 represent a “before and after” view of the color fill command. Alternatively, the color fill command could be represented by a single “after” image, or by a video snapshot (e.g., an animation sequence of images) providing a smooth transition from the “before” view to the “after” view. Of course, the snapshots may be generated as appropriate for a given command, as well as tailored to suit the needs of a particular user or application.

In one embodiment, the area included in a given snapshot 152 may be cropped (i.e., reduced) to an area affected by a command (hereafter referred to as “affected area”). The affected area may be determined by computing a minimum bounding rectangle sufficient to enclose the affected element(s). The affected area can then be expanded by adding a contextual margin to the rectangle. The contextual margin may be based on a fixed number of display units (e.g., pixels, inches, etc.) by a predetermined percentage of the rectangle, and may further be based on the particular command. That is, some commands may require a larger margin than others in order to convey the effect of a given command to a user in a visual command history.

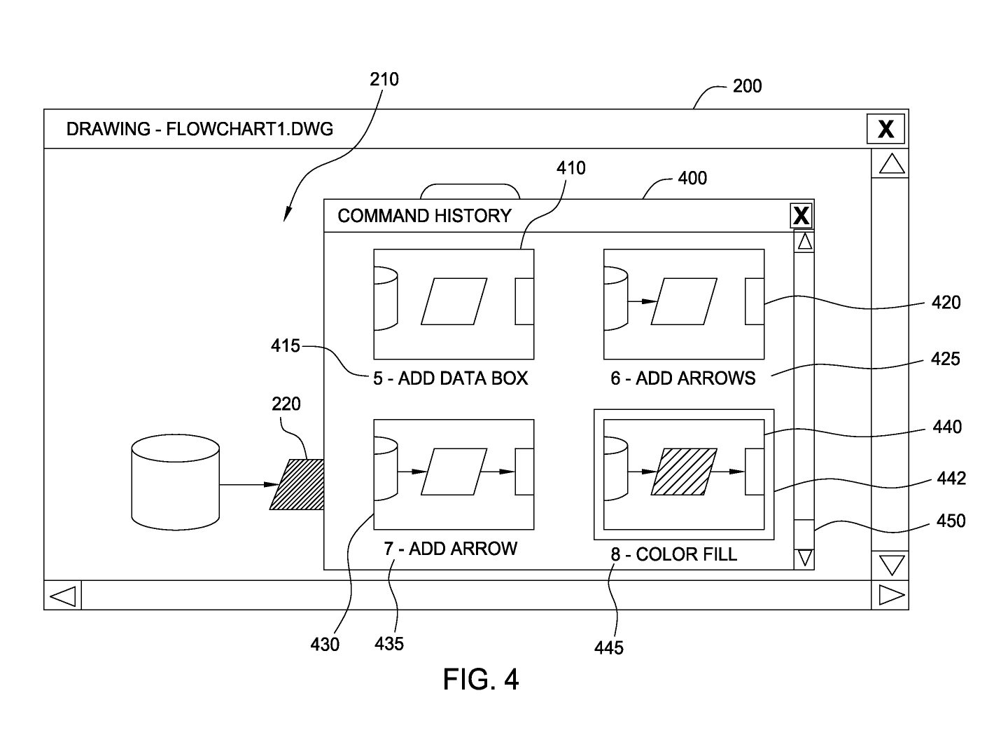

FIG. 4 illustrates screen display 200, including a visual command history 400, according to one embodiment of the invention. In this example, a user editing drawing 210 has invoked an undo function of drawing application 105. As a result, the user is provided with visual command history 400 which conveys the specific sequence of commands performed for drawing 210. In one embodiment, a user may select a specific command for the undo function. Selecting a command from visual command history 400 results in drawing 210 being restored to the state prior to the execution of the selected command. In one embodiment, commands are undone in reverse order beginning from the most recent command to the one selected from visual command history 400. Visual command history 400 may be generated by, for example, by command history tool 114 using command history 150.

As shown, visual command history 400 includes four snapshots 410, 420, 430, and 440, representing the last four commands executed in the drawing application. Visual command history 400 also includes text labels 415, 425, 435, and 445, which provide a reference number and a description for the command illustrated in the corresponding snapshot. The text labels may be generated, for example, using data stored in command records 154.

In one embodiment, a user may scroll through the visual command history 400 by using a scroll bar 450. In this example, snapshot 440 corresponds to the “fill” command discussed with reference to FIGS. 2A and 2B. Additionally, snapshot 440 provides a display of the affected area discussed above with reference to FIGS. 3A-3B. In one embodiment, the snapshot representing the last command executed in the current state of the drawing may be displayed to distinguish that command from others (e.g., highlighted or with a border). For example, snapshot 440 includes a border 442, indicating that this was the last command executed in drawing 210.

As discussed, snapshots 410, 420, 430, and 440 may be static images that represent only the results of an executed command. Alternatively, to better illustrate the effects of the executed command, the snapshots may alternate between a “before” image (as in FIG. 3A) and an “after” image (as in FIG. 3B), or may be a video sequence animating the command being executed.

Of course, a visual command history may be configured in forms other than the one illustrated in FIG. 4. In one example, a visual command history may be presented in a list of command names in which each name, when selected, may cause a snapshot 152 to be displayed. In another example, a visual command history may be presented as linear arrangement of snapshots (e.g., in a row or column). In yet another example, a visual command history may be presented as a grid of simplified snapshots that, when one is selected, is expanded into a full snapshot. These and other permutations may be used to suit the needs of a particular case.

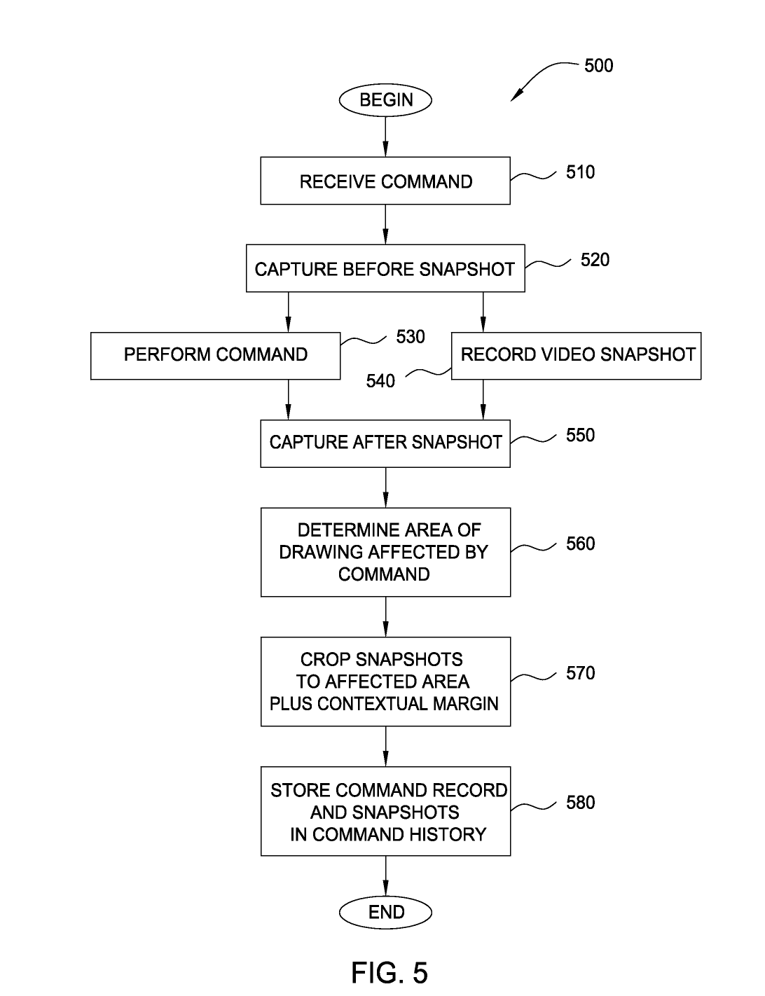

FIG. 5 illustrates a method 500 for generating a visual command history of a drawing application, according to one embodiment of the invention. Persons skilled in the art will understand that, even though the method is described in conjunction with the systems of FIGS. 1-4, any system configured to perform the steps of method 500, in any order, is within the scope of the present invention.

As shown, method 500 begins at step 510, where a user of a drawing application selects a command. This step may be performed by a user interacting with, for example, drawing editing tools 112 provided in GUI 110. At step 520, a “before” image of the CAD drawing is captured. The “before” image captures the state of the drawing 120 before the command is executed. For example, FIG. 3A illustrates a “before” image captured in snapshot 300.

At step 530, the command selected by the user is executed. This step may be performed, for example, by drawing application 105, resulting in a modification to drawing 120. Alternatively, at step 540, a video sequence may be recorded to capture changes that occur to the CAD drawing while the command is executed. The video sequence may provide an animation of the command being applied to the CAD drawing.

At step 550, an “after” image of the affected area is captured. For example, FIG. 3B illustrates an “after” image 310 reflecting the effects of a “fill” command. At step 560, the affected area of a drawing is determined. In one embodiment, the CAD application may perform a bit-wise comparison of the “before” image and the “after” image to determine a region of the display affected by the command. The affected area may be determined by determining a bounding rectangle that encloses elements of the drawing modified by the command, and optionally, expanding the rectangle by a pre-defined amount. Alternatively, the affected area may include the entire active view or window of drawing application 105.

At step 570, the snapshots captured at steps 530 and 550 may be cropped to an affected area. That is, the cropped snapshots may illustrate only those elements of the drawing that are affected by the command. The snapshots may be also be compressed to a smaller resolution than that used in the drawing application in order to reduce the storage required for the snapshots. At step 580, the snapshots may be stored in a command record describing the executed command, and the record is stored in the command history. For example, FIG. 1 illustrates command records 154 and snapshots 152 stored in command history 150. In another embodiment, the visual command history is displayed as snapshots that illustrate only the results of the commands (i.e., as “after” images). In such a case, only the snapshots captured at step 550 are stored in the visual command history. Alternatively, or additionally, if a video sequence was captured (step 540), then the video sequence may be stored in a command record as part of the visual command history.

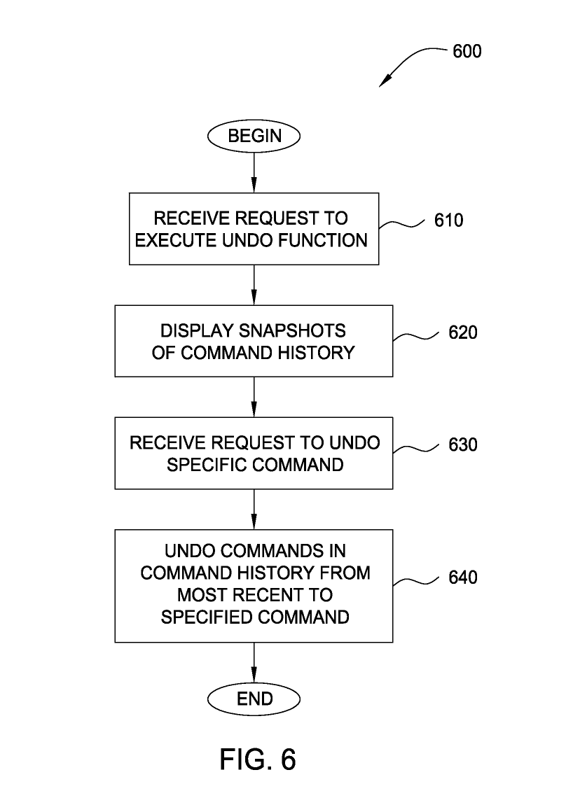

FIG. 6 illustrates a method 600 for displaying a visual command history to undo one or more modifications made to a drawing, according to one embodiment of the invention. Persons skilled in the art will understand that, even though the method is described in conjunction with the systems of FIGS. 1-4, any system configured to perform the steps of method 600, in any order, is within the scope of the present invention.

As shown, method 600 begins at step 610, where a user invokes an undo function provided by a drawing application. At step 620, the user is presented with an interface for the undo function which may include presenting the user with a visual command history. For example, FIG. 4 illustrates a visual command history 400 which includes snapshots 410, 420, 430, and 440. The visual command history may be presented by, for example, command history tool 114 illustrated in FIG. 1. The visual command history may include static “after” images, alternating sets of “before” and “after” images, or video sequences or animations.

At step 630, the user may interact with the visual command history and select a snapshot to indicate a specific command. In response, at step 640, the drawing application 105 may be configured to undo the sequence commands beginning from the most recent command up to the command selected at step 630. In other words, drawing 120 may be returned to the state it was in prior to the execution of the selected command. After step 640, the method 600 ends.

Advantageously, embodiments of the invention may be used to generate a visual command history. In one embodiment, the visual command history may include snapshots representing the commands executed while a user edits a drawing in the software application. The snapshots enable a user to visually determine the effect of previously executed commands, as well which elements of a drawing were modified by the command. The visual command history may include single snapshots, e.g., “after” images. Alternatively, the visual command history may include multiple snapshots such as a “before” image and an “after” image, or a video sequence illustrating the effect of the command as it is performed. In one embodiment, the user may select to undo the actions of a sequence of commands listed in the visual command history from the most recent command up to a selected command. The visual command history may enable the user to easily determine which previously-executed command corresponds to the desired undo state.

While the forgoing is directed to embodiments of the present invention, other and further embodiments of the invention may be devised without departing from the basic scope thereof, and the scope thereof is determined by the claims that follow.

What is claimed is:

1. A method for generating a visual command history for a software application configured to edit a computer-aided design (CAD) drawing, comprising:
receiving a selected command to perform;
performing the command;
determining an area of the CAD drawing modified by the command;
capturing at least one image of the area of the CAD drawing modified by the command; and
storing the images in the visual command history, wherein the visual command history is configured to maintain a record of each command performed by the software application.

2. The method of claim 1, wherein the step of determining the area of the CAD drawing modified by the command comprises determining an area that includes visual elements of the CAD drawing that are modified by the command.

3. The method of claim 1, further comprising, storing data describing the command, wherein the data comprises at least a command name and elements of the CAD drawing modified by the command, and wherein the data describing the command is stored in the record corresponding to the command in the visual command history.

4. The method of claim 1, wherein the step of capturing at least one image of the area of the CAD drawing modified by the command comprises:
capturing a first image of the CAD drawing before the command is performed; and
capturing a second image of the of the CAD drawing after the command is performed.

5. The method of claim 1, wherein capturing at least one image of the modified area comprises generating an animation sequence showing the command being performed to the CAD drawing.

6. The method of claim 1, wherein at least one of the images stored in the visual command history is stored using an image resolution less than the resolution of the CAD drawing.

7. The method of claim 1, wherein at least one of the images stored in the visual command history is stored using an image resolution greater than the resolution of the CAD drawing.

8. The method of claim 1, further comprising:
receiving a request to display the visual command history; and
generating a display of the visual command history, wherein the display includes the images laid out in sequence to show the sequence of commands performed to the CAD drawing using the software application.

9. The method of claim 8, wherein the request to display the visual command history is generated when the user invokes an undo function of the software application, and further comprising:
receiving a user selection of an image representing a particular command of the visual command history; and
executing the undo function such that the CAD drawing is returned to a state that existed before the particular command was performed.

10. A computer-readable storage medium storing instructions that when executed by a processor cause the processor to generate a visual command history for a software application configured to edit a computer-aided design (CAD) drawing by performing the steps of:
receiving a selected command to perform;
performing the command;
determining an area of the CAD drawing modified by the command;
capturing at least one image of the area of the drawing modified by the command; and
storing the images in the visual command history, wherein the visual command history is configured to maintain a record of each command performed by the software application.

11. The computer-readable storage medium of claim 10, wherein the step of determining the area of the CAD drawing modified by the command comprises determining an area that includes visual elements of the CAD drawing that are modified by the command.

12. The computer-readable storage medium of claim 10, wherein the instructions further comprise instructions for storing data describing the command, wherein the data comprises at least a command name and elements of the CAD drawing modified by the command, and wherein the data describing the command is stored in the record corresponding to the command in the visual command history.

13. The computer-readable storage medium of claim 10, wherein the step of capturing at least one image of the area of the CAD drawing modified by the command comprises:
capturing a first image of the CAD drawing before the command is performed; and
capturing a second image of the of the CAD drawing after the command is performed.

14. The computer-readable storage medium of claim 10, wherein capturing at least one image of the modified area comprises generating an animation sequence showing the command being performed to the CAD drawing.

15. The computer-readable storage medium of claim 10, wherein at least one of the images stored in the visual command history is stored using an image resolution less than the resolution of the CAD drawing.

16. The computer-readable storage medium of claim 10, wherein at least one of the images stored in the visual command history is stored using an image resolution greater than the resolution of the CAD drawing.

17. The computer-readable storage medium of claim 10, wherein the instructions further comprise instructions for:
receiving a request to display the visual command history; and
generating a display of the visual command history, wherein the display includes the images laid out in sequence to show the sequence of commands performed to the CAD drawing using the software application.

18. The computer-readable storage medium of claim 17, wherein the request to display the visual command history is generated when the user invokes an undo function of the software application, and wherein the instructions further comprise instructions for:
receiving a user selection of an image representing a particular command of the visual command history; and
executing the undo function such that the CAD drawing is returned to a state that existed before the particular command was performed.

19. A method for using a visual command history to undo a sequence of actions performed to a computer-aided design (CAD) drawing, the method comprising:
invoking a command history viewer configured to display one or more images stored in the visual command history, wherein each image is associated with one of a plurality of previously executed commands;
selecting one of the displayed images; and
invoking an undo tool configured to:
receive a selected command to perform; and
undo the sequence of commands in reverse order beginning with a most-recently executed command and ending with the previously-executed command corresponding to the selected display image, wherein the CAD drawing is returned to a state that existed before the previously-executed command corresponding to the selected display image was performed.

20. The method of claim 19, wherein each of the images stored in the visual command history display an area of the CAD drawing modified by the associated previously-executed command.

21. The method of claim 19, wherein the visual command history for one of the previously executed commands includes a first image of the CAD drawing captured before that previously executed command is performed and includes a second image of the CAD drawing captured after that previously executed command is performed.

22. The method of claim 19, wherein the visual command history for one of the previously executed commands includes an animation sequence showing the command being performed to the CAD drawing.

23. The method of claim 19, wherein capturing at least one image of the modified area comprises generating an animation sequence showing the command being performed to the CAD drawing.

24. The method of claim 19, wherein at least one of the images stored in the visual command history is stored using an image resolution less than the resolution of the CAD drawing.
